(19) United States
(12) Patent Application Publication
(10) Pub. No.: US 2008/0062376 A1
(43) Pub. Date: Mar. 13, 2008

(54) METHOD OF FABRICATING A LIQUID CRYSTAL PANEL AND ALIGNMENT METHOD

(75) Inventors: Pei-Wen Ko, Taipei City (TW); Da-Shuang Kuan, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: UNITED MICRODISPLAY OPTRONICS CORP., Hsin-Chu City (TW)

(21) Appl. No.: 11/530,907

(22) Filed: Sep. 12, 2006

(51) Int. Cl. G02F 1/1341

(52) U.S. Cl. 349/189

(57) ABSTRACT

A method of fabricating a liquid crystal panel is provided. First, a first substrate having a pixel array thereon is provided. Next, a sealing frame is formed on the first substrate around the pixel array. Next, a liquid crystal inkjet printing step is conducted to the region surrounded by the sealing frame to perform an alignment process. Then, the liquid crystal inkjet printing step is still performed to fill a liquid crystal material within the region surrounded by the sealing frame. Thereafter, a second substrate having an electrode layer thereon is provided. Then, the first and second substrates are assembled together through the sealing frame.

### BACKGROUND OF THE INVENTION

1. Field of the Invention

The present invention relates to a method of fabricating a liquid crystal panel and an alignment method, and more particularly, to a method of conducting alignment by using a liquid crystal inkjet printing step and a method of fabricating liquid crystal panel by using this alignment method.

2. Description of Related Art

A liquid crystal panel is formed by two substrates and a liquid crystal layer sandwiched there-between. Generally, during the fabricating process of a liquid crystal panel, an alignment film is formed on the two substrates respectively, such that the liquid crystal molecules have specific pre-tilt angles or arrangement directions before the liquid crystal panel is driven. The conventional method of forming the alignment film is coating an alignment material, and then, conducting an alignment process to the alignment material. The alignment process can be divided into a contact alignment process and a non-contact alignment process. The contact alignment process is typically roller rubbing alignment; the non-contact alignment process includes ion beam alignment process, photo-alignment process, silicon oxide oblique evaporation alignment, etc.

However, in the above-mentioned various alignment methods, the disadvantage of the silicon oxide oblique evaporation alignment lies in the non-uniformity of the alignment, and the cleaning process and the liquid crystal filling process performed after the alignment process often easily cause damages to the silicon oxide alignment film. Further, as the roller rubbing alignment method and the photo-alignment method require an organic alignment material, not only the selection of the alignment material is limited, but the type of the applicable display panel is also limited due to using an organic alignment material, because the organic material easily deteriorates after a long time strong light irradiation. For example, an organic alignment material is not suitable to be used in a liquid crystal on silicon (LCOS) panel.

### SUMMARY OF THE INVENTION

An objective of the present invention is to provide an alignment method, which solves problems of the conventional contact or non-contact alignment method.

Another objective of the present invention is to provide a method of fabricating a liquid crystal panel, wherein the alignment method of the present invention is used to fabricate the liquid crystal panel.

Still another objective of the present invention is to provide a method of fabricating a liquid crystal panel, which eliminates the disadvantages of the conventional alignment method and simplifies the fabricating process of the liquid crystal panel.

The present invention provides a method of fabricating a liquid crystal panel. First, a first substrate having a pixel array thereon is provided. Next, a sealing frame is formed on the first substrate around the pixel array. Next, a liquid crystal inkjet printing step is conducted to the region surrounded by the sealing frame to perform an alignment process. Then, the liquid crystal inkjet printing step is still performed to fill a liquid crystal material into the region surrounded by the sealing frame. Thereafter, a second substrate having an electrode layer thereon is provided. Then, the first substrate and the second substrate are assembled together through the sealing frame, so as to form a liquid crystal panel.

According to an embodiment of the present invention, before conducting the liquid crystal inkjet printing step, it further comprises forming an alignment material on the first substrate to cover the pixel array. In an embodiment, after forming the alignment material, an alignment process is performed to the alignment material, and then, the liquid crystal inkjet printing step is performed to the alignment material.

According to an embodiment of the present invention, the above-mentioned first substrate is a silicon wafer, and the second substrate is a glass plate.

According to an embodiment of the present invention, the liquid crystal inkjet printing step comprises: disposing an inkjet head above the first substrate; and moving the first substrate or the inkjet head, so that the whole region surrounded by the sealing frame achieves the alignment effect. In an embodiment, the inkjet head comprises a plurality of nozzles arranged in a matrix. In another embodiment, the angle between the inkjet head and the surface of the first substrate is 30-90 degrees.

The present invention provides a method of fabricating a liquid crystal panel. First, a first substrate having a pixel array thereon and a second substrate having an electrode layer thereon are provided. Next, a sealing frame is formed on the first substrate and the second substrate respectively around the pixel array and the electrode layer. Then, a liquid crystal inkjet printing step is performed to the first substrate and the second substrate respectively to conduct an alignment process to the first substrate and the second substrate. Then, the liquid crystal inkjet printing step is still performed to fill a liquid crystal material into the regions surrounded by the sealing frame. Finally, the first substrate and the second substrate are assembled together through the sealing frame, so as to form a liquid crystal panel.

According to an embodiment of the present invention, before conducting the liquid crystal inkjet printing step, it further comprises forming an alignment material on the first substrate and the second substrate respectively for covering the pixel array and the electrode layer. In an embodiment, after forming the alignment material, an alignment process is performed to the alignment material, and then, the liquid crystal inkjet printing step is performed to the alignment material.

According to an embodiment of the present invention, the first substrate is a silicon wafer, and the second substrate is a glass plate.

According to an embodiment of the present invention, the liquid crystal inkjet printing step comprises: disposing an inkjet head above the first substrate and the second substrate respectively; and moving the first/second substrate or the inkjet head, so that the whole region surrounded by the sealing frame achieves the alignment effect. In an embodiment, the inkjet head comprises a plurality of nozzles arranged in a matrix. In an embodiment, the angle between the inkjet head and the surface of the first substrate or the second substrate is 30-90 degrees.

The present invention further provides an alignment method. First, a substrate having a film layer thereon is provided. Then, a liquid crystal inkjet printing step is performed to the substrate, so as to conduct an alignment process to the film layer.

According to an embodiment of the present invention, the film layer is an alignment material.

According to an embodiment of the present invention, the film layer is an electrode layer or an insulating layer.

According to an embodiment of the present invention, the liquid crystal inkjet printing step comprises: disposing an inkjet head above the substrate; and moving the substrate or the inkjet head, so that the whole film layer achieves the alignment effect. In an embodiment, the inkjet head comprises a plurality of nozzles arranged in a matrix. In another embodiment, the angle between the inkjet head and the surface of the substrate is 30-90 degrees.

The present invention utilizes the liquid crystal inkjet printing step to accomplish the alignment process and the process of filling a liquid crystal material. Therefore, compared with the conventional method of fabricating a liquid crystal panel in which the alignment process and the process of filling the liquid crystal material are accomplished by utilizing two different processes, the present invention has the advantages of simplified fabricating flow and reduced production time.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A-1E are schematic cross-sectional views of a flow of fabricating a liquid crystal panel according to a first embodiment of the present invention.

FIG. 2 is a top view of a wafer.

FIG. 3 is an alternative form of the first embodiment of the present invention, utilizing the liquid crystal inkjet printing step to perform an alignment process to the alignment material.

FIG. 4 is a schematic view of using an inkjet head in the liquid crystal inkjet printing step according to an embodiment of the present invention.

FIGS. 5A-5C are schematic cross-sectional views of a flow of fabricating a liquid crystal panel according to a second embodiment of the present invention.

FIG. 6 is an alternative form of the second embodiment of the present invention, which utilizes the liquid crystal inkjet printing step to perform an alignment process to the alignment material.

FIG. 7 is a schematic view of a testing liquid crystal panel.

FIGS. 8A-8D are test pictures of the liquid crystal panel.

### DESCRIPTION OF EMBODIMENTS

### First Embodiment

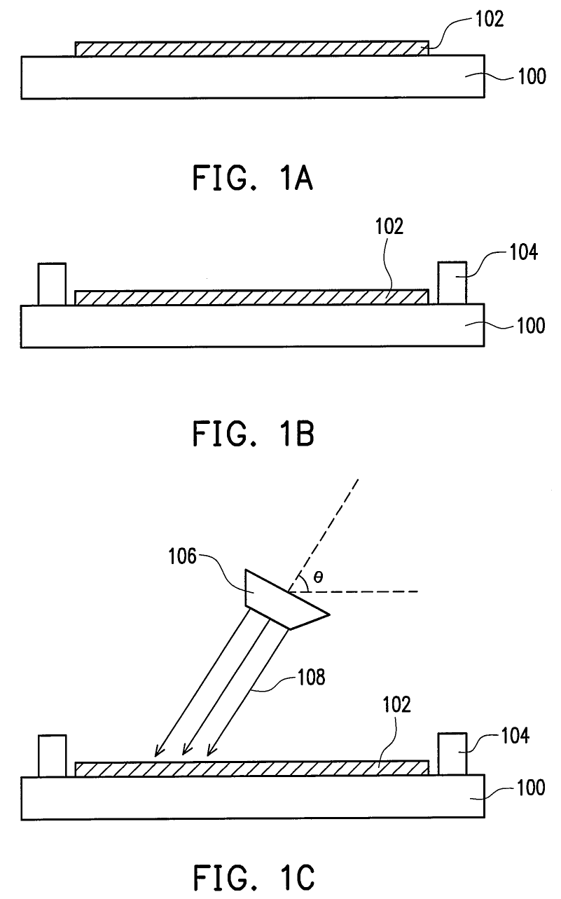

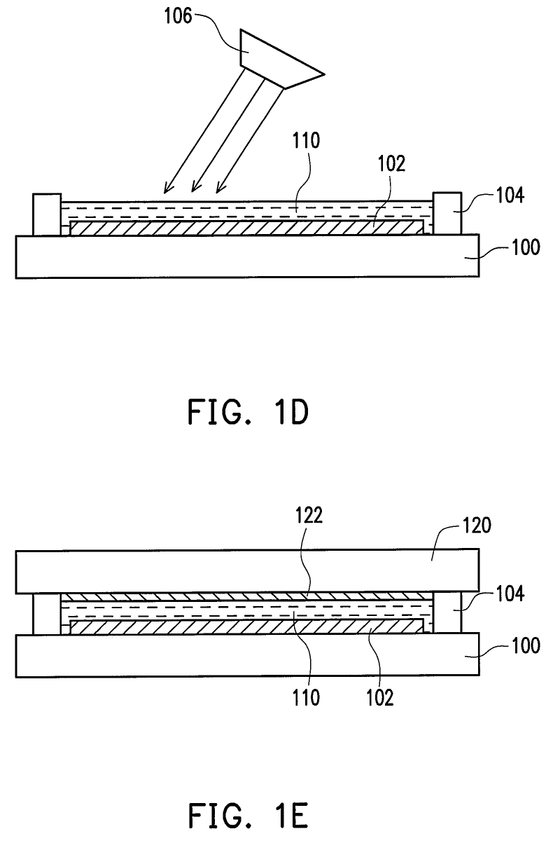

FIGS. 1A-1E are schematic cross-sectional views of a flow of fabricating a liquid crystal panel according to a first embodiment of the present invention. Referring to FIG. 1A, first, a first substrate 100 having a pixel array 102 thereon is provided. In an embodiment, the first substrate 100 is a part of a silicon wafer, thus, the one shown in FIG. 1A is a display panel unit 12 on the silicon wafer 10 of FIG. 2. If the present invention utilizes a silicon wafer as the first substrate, the liquid crystal panel fabricated subsequently is a liquid crystal on silicon (LCOS) panel. Certainly, the present invention is not limited to this. The method of the present invention may also be applied to other kinds of liquid crystal panels, that is, the material of the first substrate 100 may also be glass or plastic, etc. Further, if the liquid crystal panel of the present invention is an active liquid crystal panel, the pixel array 102 formed on the first substrate 100 comprises a plurality of active elements and a plurality of pixel electrodes (not shown). If the liquid crystal panel of the present invention is a passive liquid crystal panel, the pixel array 102 formed on the first substrate 100 is constituted of a plurality of electrode patterns. According to other embodiments of the present invention, other film layers may be additionally formed on the pixel array 102, for example, a color filter layer, etc.

Then, referring to FIG. 1B, a sealing frame 104 is formed on the first substrate 100 around the above formed pixel array 102. The sealing frame 104 is, for example, a sealing material, which is hardened upon being heated or light irradiated.

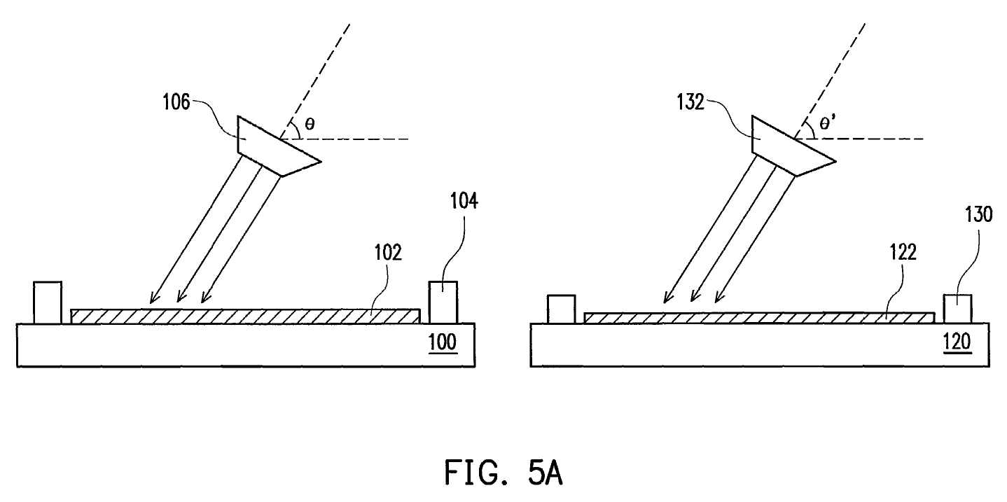

Then, referring to FIG. 1C, a liquid crystal inkjet printing step is conducted to the region surrounded by the sealing frame 104 to perform an alignment process 108, that is, to perform the alignment process 108 to the surface layer of the pixel array 102. In an embodiment, the method of performing the above-mentioned liquid crystal inkjet printing step is, for example, to dispose an inkjet head 106 above the first substrate 100, and then, move the first substrate 100 or the inkjet head 106, so that the whole surface layer of the pixel array 102 surrounded by the sealing frame 104 can achieve the alignment effect. In other words, in order to make the whole region surrounded by the sealing frame 104 (the region where the pixel array 102 is located) achieve the alignment effect, the method of moving the first substrate 100 but fixing the inkjet head 106 may be utilized; or the method of moving the inkjet head 106 but fixing the first substrate 100 may be used. Further, the inkjet head 106 is inclined by an angle to inject the liquid crystal to the first substrate 100. That is, there is an angle θ between the inkjet head 106 and the surface of the first substrate 100, which may be any one between 30 and 90 degrees. In addition, the inkjet head 106 may also be disposed with a single nozzle or a plurality of nozzles 106a arranged in a matrix (as shown in FIG. 4). The speed for the inkjet head 106 to inject liquid crystals is relevant to the aperture of the nozzle 106a and the thickness of the liquid crystal material to be formed subsequently.

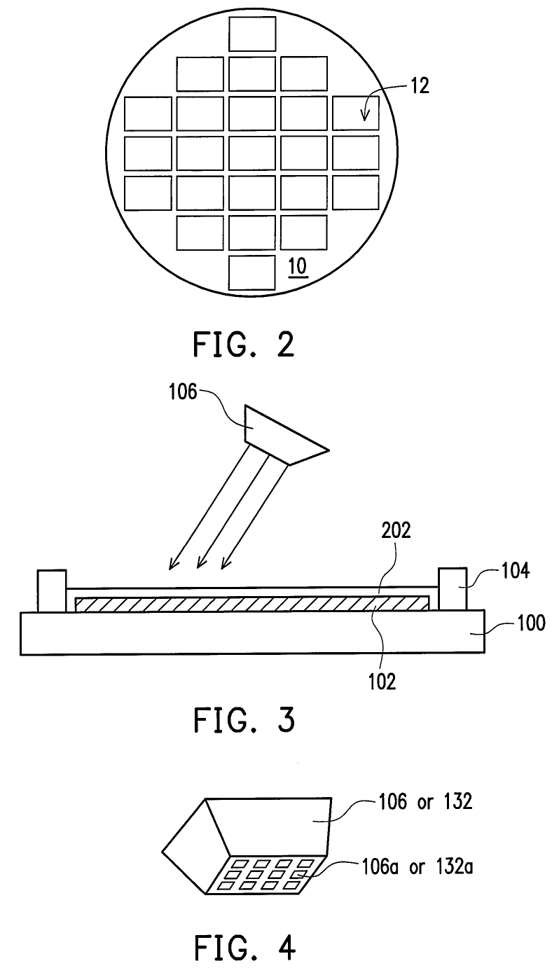

It should be mentioned that, the present embodiment uses the liquid crystal inkjet printing step to perform the alignment process directly to the surface layer of the pixel array 102, and the surface layer of the pixel array 102 is, for example, a conductive layer (for example, indium tin oxide or indium zinc oxide) or an insulating layer (for example, silicon oxide or silicon nitride). However, the present invention is not limited to this. According to another preferred embodiment of the present invention, before conducting the liquid crystal inkjet printing step, an alignment material is formed first. As shown in FIG. 3, an alignment material 202 is first formed on the first substrate 100 to cover the pixel array 102. Then, the inkjet head 106 is used to perform an alignment process to the alignment material 202. The alignment material 202 may be an organic alignment material, e.g., polyimide, or an inorganic alignment material, e.g., silicon oxide or an inorganic alignment material disclosed in U.S. Pat. No. 6,426,786. According to another preferred embodiment of the present invention, after forming the alignment material 202, an alignment process is first conducted to the alignment material 202, for example, an ion beam alignment process, a photo-alignment process, a rubbing alignment process or an oblique evaporation alignment. Thus, the alignment material 202 already had an alignment effect at this time. Then, when the inkjet head 106 is used again to perform an alignment process to the aligned alignment material 202, the alignment of the aligned alignment material 202 can be adjusted or modified, for example, enhancing or strengthening the alignment effect, or adjusting the alignment angle. For example, if the direction of the liquid crystal inkjet printing step follows the original alignment direction, the liquid crystal inkjet printing step enhances the alignment of the aligned alignment material.

It should be noted that, as the liquid crystal inkjet method is utilized in the present embodiment to perform the alignment process, the present embodiment may also perform a multi-domain alignment process to the film layer on the first substrate (for example, the surface layer of the pixel array or the alignment material). That is, during the process of the liquid crystal inkjet alignment, an alignment process in different directions is performed to different regions on the first substrate by changing the direction of the inkjet head. Thus, the multi-domain alignment effect occurs to the first substrate.

After the liquid crystal inkjet printing step is used to conduct the alignment process, referring to FIG. 1D, the inkjet head 106 is still used to conduct the liquid crystal inkjet printing step to fill a liquid crystal material 110 into the region surrounded by the sealing frame 104. Therefore, the present embodiment utilizes the liquid crystal inkjet printing step to accomplish both the alignment process and the filling of the liquid crystal material at the same time, so it has the advantage of simplified fabricating flow and reduced production time. In addition, as the present embodiment utilizes the inkjet method to fill the liquid crystals, it has the advantage of precisely controlling the amount of the liquid crystals, as compared with the conventional liquid crystal One-Drop Fill (ODF) process.

Then, referring to FIG. 1E, a second substrate 120 having an electrode layer 122 thereon is provided. The second substrate 120 is, for example, a glass plate or other suitable plate materials. The electrode layer 122 is, for example, a transparent electrode such as indium tin oxide or indium zinc oxide. According to another embodiment of the present invention, other film layers may be formed on the electrode layer 122, for example, an insulating layer, a color filter layer, etc. Next, the second substrate 120 is disposed above the first substrate 100, and both the substrates 100, 120 are assembled together through the sealing frame 104, so as to form a liquid crystal panel.

The present invention not only utilizes the liquid crystal inkjet printing step to conduct the alignment process to the first substrate, but also utilizes the liquid crystal inkjet printing step to conduct the alignment process to both the surface layer of the first substrate and that of the second substrate, which is illustrated below in detail.

### Second Embodiment

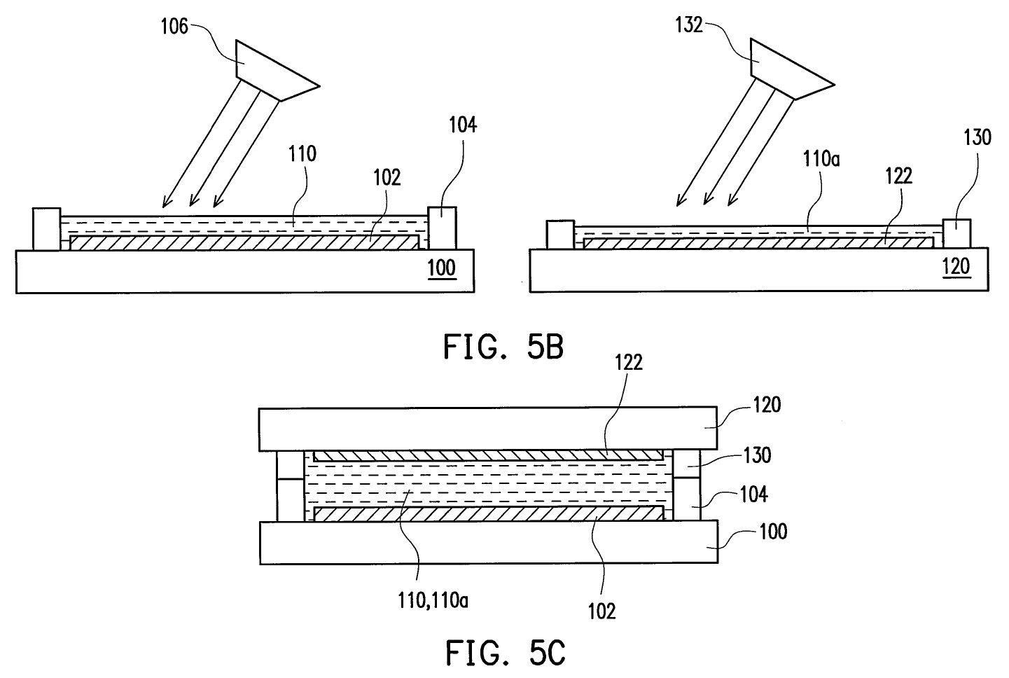

FIGS. 5A-5C are schematic cross-sectional views of a flow of fabricating a liquid crystal panel according to a second embodiment of the present invention. Referring to FIG. 5A, first, a first substrate 100 having a pixel array 102 thereon and a second substrate 120 having an electrode layer 122 thereon are provided. The materials of the first and second substrates 100, 120 and the materials of the pixel array 102 and the electrode layer 122 are the same as or similar to that mentioned in the first embodiment, which thus will not be described herein any more. Next, sealing frames 104, 130 are formed on the first substrate 100 and the second substrate 120 around the pixel array 102 and the electrode layer 122 respectively. The sealing frames 104, 130 are, for example, a sealing material, which is hardened upon being heated or light irradiated.

Then, a liquid crystal inkjet printing step is performed to the first substrate 100 and the second substrate 120 to conduct an alignment process to the first substrate 100 and the second substrate 120 respectively. In an embodiment, the above liquid crystal inkjet printing step is performed as follows. First, inkjet heads 106, 132 are disposed above the first substrate 100 and the second substrate 120 respectively. Then, the first substrate 100 or the inkjet head 106 is moved, so that the whole surface layer of the pixel array 102 achieves the alignment effect. On the other aspect, the second substrate 120 or the inkjet head 132 is moved, so that the whole surface layer of the electrode layer 122 achieves the alignment effect. In other words, in order to make the whole region surrounded by the sealing frame 104 or 132 (the region where the pixel array 102 or the electrode layer 122 is located) achieve the alignment effect, the method of moving the first substrate 100 and fixing the inkjet head 106 and the method of moving the second substrate 120 and fixing the inkjet head 132 may be utilized; or the method of moving the inkjet head 106 and fixing the first substrate 100 and the method of moving the inkjet head 132 and fixing the second substrate 120 may be utilized. Similarly, the inkjet head 106 is inclined by an angle to inject the liquid crystals to the first substrate 100, and the inkjet head 132 is also inclined by an angle to inject the liquid crystals to the second substrate 120. That is, there is an angle θ between the inkjet head 106 and the surface of the first substrate 100, which may be any one between 30 and 90 degrees; and there is an angle θ′ between the inkjet head 132 and the surface of the second substrate 120, which may be any one between 30 and 90 degrees, wherein the angle θ and the angle θ′ can be the same or different. In addition, the inkjet head 106 or 132 may also be equipped with a single nozzle or a plurality of nozzles 106a or 132a arranged in a matrix (as shown in FIG. 4). The speed for the inkjet head 106, 132 to inject liquid crystals is relevant to the apertures of the nozzles 106a, 132a and the thickness of the liquid crystal material to be formed subsequently.

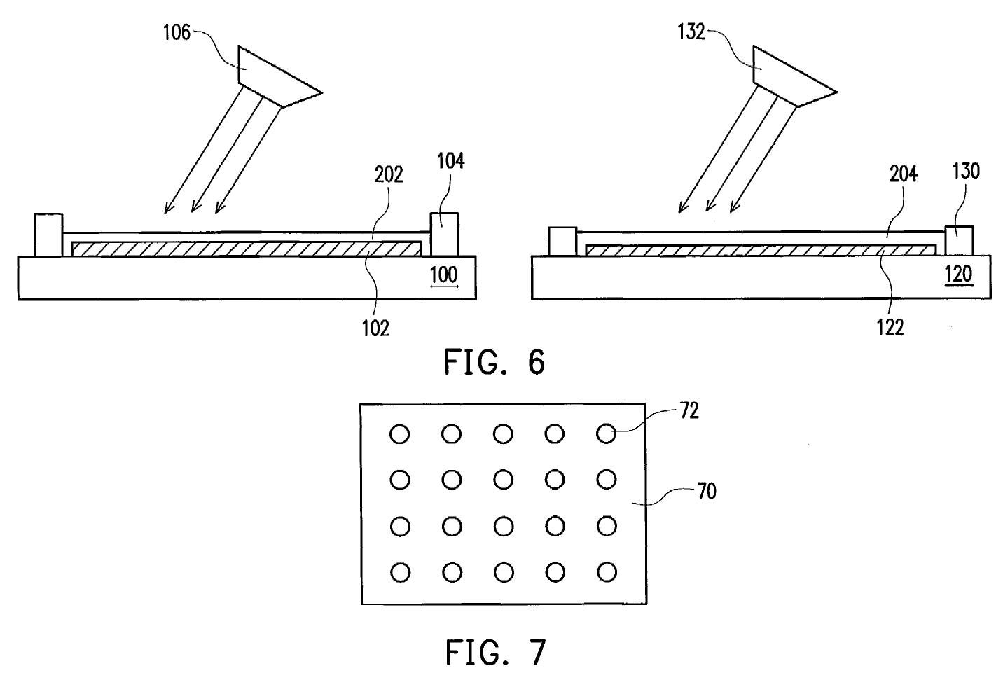

Similarly, this embodiment uses the liquid crystal inkjet printing step to perform the alignment process directly to the surface layer of the pixel array 102 or the electrode layer 122, wherein the surface layer of the pixel array 102 is, for example, a conductive layer (for example, indium tin oxide or indium zinc oxide) or an insulating layer (for example, silicon oxide or silicon nitride). However, the present invention is not limited to this. According to another preferred embodiment of the present invention, before the liquid crystal inkjet printing step, an alignment material may be formed first in the present embodiment. As shown in FIG. 6, first, an alignment material 202 is formed on the first substrate 100 to cover the pixel array 102. Then, the inkjet head 106 is used to perform an alignment process to the alignment material 202. On the other aspect, first, an alignment material 204 is formed on the second substrate 120 to cover the electrode layer 122. Then, the inkjet head 132 is used to perform an alignment process to the alignment material 204. The alignment materials 202, 204 may be an organic alignment material, for example, polyimide, or an inorganic alignment material, for example, silicon oxide or an inorganic alignment material disclosed in U.S. Pat. No. 6,426,786. According to another preferred embodiment of the present invention, after forming the alignment materials 202, 204, it may first conduct an alignment process to the alignment materials 202, 204, for example, an ion beam alignment process, a photo-alignment process, a rubbing alignment process or an oblique evaporation alignment. Thus, the alignment material 202 already has the alignment effect at this time. Then, when the inkjet head 106 is used again to perform an alignment process to the aligned alignment materials 202, 204, the alignment of the aligned alignment materials 202, 204 can be adjusted or modified, for example, the alignment effect is enhanced or strengthened, or the alignment angle is adjusted.

It should be noted that, as the liquid crystal inkjet method is utilized in the present embodiment to perform the alignment process, the present embodiment may also perform a multi-domain alignment process to the film layer of the first substrate and that of the second substrate (for example, the surface layers of the pixel array and the electrode layer or the alignment material). That is, during the process of the liquid crystal inkjet alignment, an alignment process in different directions is performed to different regions on the first and second substrates by changing the direction of the inkjet head. Thus, the multi-domain alignment effect occurs to the first substrate and the second substrate.

After the liquid crystal inkjet printing step is used to conduct the alignment process, referring to FIG. 5B, the inkjet heads 106, 132 are still used to conduct the liquid crystal inkjet printing step to fill liquid crystal materials 110, 110a into the regions surrounded by the sealing frames 104, 130. According to another embodiment, it may continue to perform the process of filling the liquid crystals only on the first substrate 100 or the second substrate 120 after the inkjet step is used to conduct the alignment process. Then, referring to FIG. 5C, the first and second substrates 100, 120 are assembled together through the sealing frames 104, 130, so as to form a liquid crystal panel.

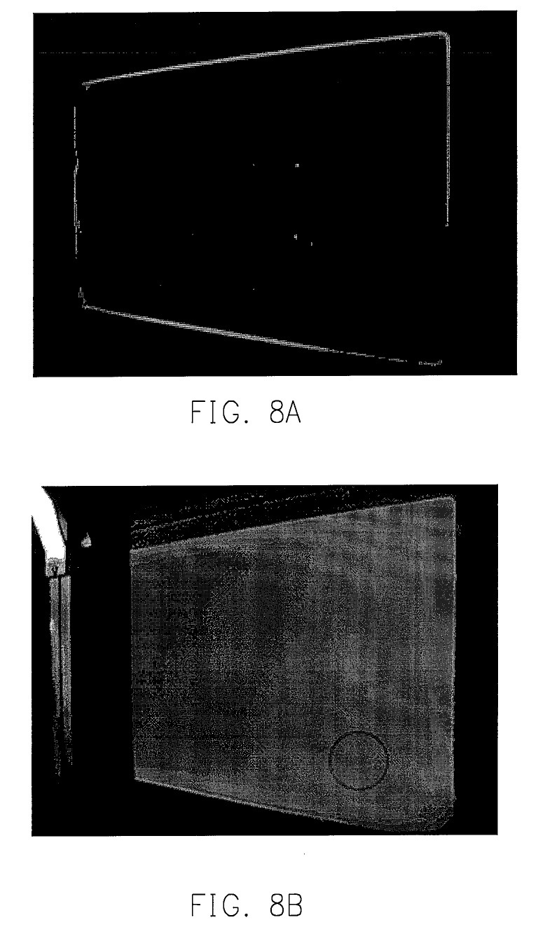

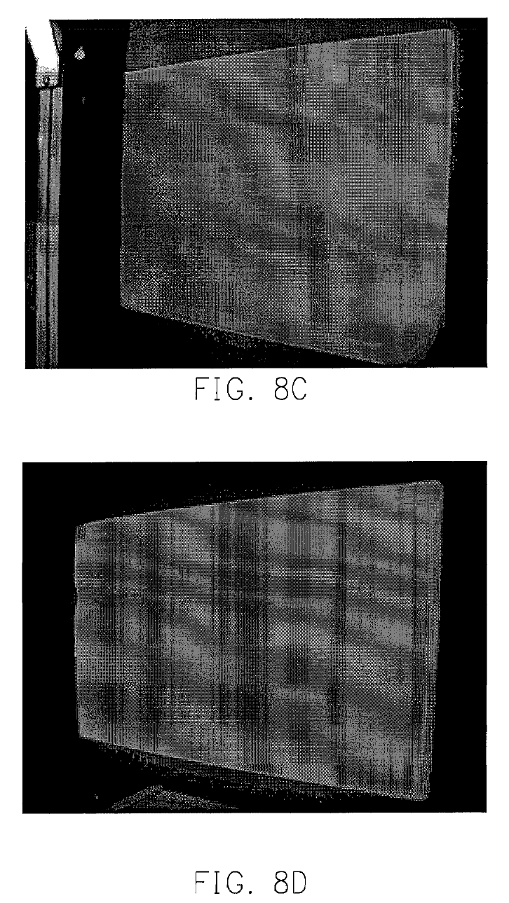

In order to prove that using the liquid crystal inkjet method to conduct alignment indeed can achieve the alignment effect, the following several experiments are used for illustration. In the liquid crystal panel shown in FIGS. 8A-8D, the method as shown in FIG. 7 is used to perform an alignment process at a plurality of positions 72 on the substrate 70 in a liquid crystal inkjet manner. FIGS. 8A-8D show grey scale conditions respectively generated under driving voltages (0% V, 15% V, 25% V, 100% V). It is obviously known from the drawings that, as the region injected by the liquid crystal inkjet and the region without being injected by the liquid crystal inkjet apparently generate different alignment forces and pre-tilt angle variations during the grey scale display, it is proved that the present invention indeed achieves the alignment effect by using the liquid crystal inkjet manner to conduct the alignment process.

To sum up, the present invention has the following advantages:

1. Since the present invention utilizes the liquid crystal inkjet manner to accomplish both the alignment process and the filling of the liquid crystal material, the method of the present invention has the advantages of simplified fabricating flow and reduced production time, as compared with the conventional method of fabricating a liquid crystal panel, in which the alignment process and the filling of the liquid crystal material are accomplished through two different processes.

2. Since the present invention employs the liquid crystal inkjet manner to accomplish the filling of the liquid crystal material, it has the advantage of precisely controlling the amount of liquid crystals, as compared with the conventional liquid crystal one-drop fill process.

3. The present invention utilizes the liquid crystal inkjet manner to perform the alignment process again to the aligned film layer, so as to strengthen or modify the original alignment effect.

4. The present invention utilizes the liquid crystal inkjet manner to conduct an alignment process to the organic or inorganic material, thus, the user may optionally select any suitable alignment material according to the actual product design requirements.

What is claimed is:

1. A method of fabricating a liquid crystal panel, comprising:
providing a first substrate having a pixel array thereon;
forming a sealing frame on the first substrate around the pixel array;
conducting a liquid crystal inkjet printing step to the region surrounded by the sealing frame to perform an alignment process;
still performing the liquid crystal inkjet printing step to fill a liquid crystal material into the region surrounded by the sealing frame;
providing a second substrate having an electrode layer thereon; and
assembling the first substrate and the second substrate together through the sealing frame.

2. The method of fabricating a liquid crystal panel as claimed in claim 1, further comprising forming an alignment material on the first substrate to cover the pixel array, before conducting the liquid crystal inkjet printing step.

3. The method of fabricating a liquid crystal panel as claimed in claim 2, wherein after forming the alignment material, an alignment process is performed to the alignment material, and then the liquid crystal inkjet printing step is performed to the alignment material.

4. The method of fabricating a liquid crystal panel as claimed in claim 1, wherein the first substrate is a silicon wafer, and the second substrate is a glass plate.

5. The method of fabricating a liquid crystal panel as claimed in claim 1, wherein the liquid crystal inkjet printing step comprises:
disposing an inkjet head above the first substrate; and
moving the first substrate or the inkjet head, so that the whole region surrounded by the sealing frame achieves the alignment effect.

6. The method of fabricating a liquid crystal panel as claimed in claim 5, wherein the inkjet head comprises a plurality of nozzles arranged in a matrix.

7. The method of fabricating a liquid crystal panel as claimed in claim 5, wherein the angle between the inkjet head and the surface of the first substrate is 30-90 degrees.

8. A method of fabricating a liquid crystal panel, comprising:
providing a first substrate having a pixel array thereon and a second substrate having an electrode layer thereon;
forming a sealing frame on the first substrate and the second substrate around the pixel array and the electrode layer respectively;
conducting a liquid crystal inkjet printing step to the first substrate and the second substrate respectively, so as to perform an alignment process to the first substrate and the second substrate;
still performing the liquid crystal inkjet printing step to fill a liquid crystal material into the region surrounded by the sealing frame; and
assembling the first substrate and the second substrate together through the sealing frame.

9. The method of fabricating a liquid crystal panel as claimed in claim 8, further comprising forming an alignment material on the first substrate and the second substrate to cover the pixel array and the electrode layer respectively, before conducting the liquid crystal inkjet printing step.

10. The method of fabricating a liquid crystal panel as claimed in claim 9, wherein after forming the alignment material, an alignment process is performed to the alignment material, and then the liquid crystal inkjet printing step is performed to the alignment material.

11. The method of fabricating a liquid crystal panel as claimed in claim 9, wherein the first substrate is a silicon wafer, and the second substrate is a glass plate.

12. The method of fabricating a liquid crystal panel as claimed in claim 9, wherein the liquid crystal inkjet printing step comprises:
disposing an inkjet head above the first substrate and the second substrate respectively; and
moving the first/second substrate or the inkjet head, so that the whole region surrounded by the sealing frame achieves the alignment effect.

13. The method of fabricating a liquid crystal panel as claimed in claim 12, wherein the inkjet head comprises a plurality of nozzles arranged in a matrix.

14. The method of fabricating a liquid crystal panel as claimed in claim 12, wherein the angle between the inkjet head and the surface of the first substrate or that of the second substrate is 30-90 degrees.

15. An alignment method, comprising:
providing a substrate having a film layer thereon; and
conducting a liquid crystal inkjet printing step to the substrate, so as to perform an alignment process to the film layer.

16. The alignment method as claimed in claim 15, wherein the film layer is an alignment material.

17. The alignment method as claimed in claim 15, wherein the film layer is an electrode layer or an insulating layer.

18. The method of fabricating a liquid crystal panel as claimed in claim 15, wherein the liquid crystal inkjet printing step comprises:
disposing an inkjet head above the substrate; and
moving the substrate or the inkjet head, so that the whole film layer achieves the alignment effect.

19. The method of fabricating a liquid crystal panel as claimed in claim 18, wherein the inkjet head comprises a plurality of nozzles arranged in a matrix.

20. The method of fabricating a liquid crystal panel as claimed in claim 18, wherein the angle between the inkjet head and the surface of the substrate is 30-90 degrees.
